(19) United States
(12) Patent Application Publication
(10) Pub. No.: US 2022/0216539 A1
(43) Pub. Date: Jul. 7, 2022

(54) HIGH TEMPERATURE LITHIUM AIR BATTERY

(71) Applicant: Johnson IP Holding, LLC, Atlanta, GA (US)

(72) Inventor: Lonnie G. JOHNSON, Atlanta, GA (US)

(21) Appl. No.: 17/567,631

(22) Filed: Jan. 3, 2022

Related U.S. Application Data
(60) Provisional application No. 63/153,415, filed on Feb. 25, 2021.
(60) Provisional application No. 63/133,896, filed on Jan. 5, 2021.

(51) Int. Cl. H01M 10/6561; H01M 10/0525; H01M 10/613; H01M 10/653

(52) U.S. Cl. CPC H01M 10/6561; H01M 10/653; H01M 10/613; H01M 10/0525

(57) ABSTRACT

A lithium air battery system includes a thermally insulating housing, at least one lithium air cell positioned inside the thermally insulating housing, a supply of air, a recuperative heat exchanger, and first and second conduits. The thermally insulating housing has at least one wall including at least one heat reflective layer and at least one vacuum layer. The first and second conduits couple the heat exchanger with the thermally insulating housing. During operation, the first conduit conducts air flow in a first direction through the recuperative heat exchanger and into the thermally insulating housing and the second conduit conducts air flow out of the thermally insulating housing and through the recuperative heat exchanger in a second direction which is opposite to the first direction. The recuperative heat exchanger transfers heat from the air flowing out of the thermally insulating housing to the air flowing into the thermally insulating housing.

### CROSS-REFERENCE TO RELATED APPLICATION

This application claims priority to U.S. Provisional Application No. 63/133,896, filed Jan. 5, 2021, and U.S. Provisional Application No. 63/153,415, filed Feb. 25, 2021, the disclosures of which are herein incorporated by reference.

### BACKGROUND OF THE INVENTION

The need for high performance and reliable energy storage in the modern society is well documented. Lithium batteries represent a very attractive solution to these energy needs due to their superior energy density and high performance. However, available Li-ion storage materials limit the specific energy of conventional Li-ion batteries. While lithium has one of the highest specific capacities of any anode (3861 mAh/g), typical cathode materials such as MnO₂, V₂O₅, LiCoO₂ and (CF)n have specific capacities less than 200 mAh/g.

Recently, lithium/oxygen (Li/O₂) or lithium air batteries have been suggested as a means for avoiding the limitations of today's lithium ion cells. In these batteries, lithium metal anodes are used to maximize anode capacity and the cathode capacity of lithium air batteries is maximized by not storing the cathode active material in the battery. Instead, ambient O₂ is reduced on a catalytic air electrode to form O₂²⁻, where it reacts with Li⁺ ions conducted from the anode. Aqueous lithium air batteries have been found to suffer from corrosion of the Li anode by water and suffer from less than optimum capacity because of the excess water required for effective operation.

Abraham and Jiang (J. Electrochem. Soc., 143 (1), 1-5 (1996)) reported a non-aqueous Li/O₂ battery with an open circuit voltage close to 3 V, an operating voltage of 2.0 to 2.8 V, good coulomb efficiency, and some re-chargeability, but with severe capacity fade, limiting the lifetime to only a few cycles. Further, in non-aqueous cells, the electrolyte has to wet the lithium oxygen reaction product in order for it to be electrolyzed during recharge. It has been found that the limited solubility of the reaction product in available organic electrolytes necessitates the use of excess amounts of electrolyte to adequately wet the extremely high surface area nanoscale discharge deposits produced in the cathode. Thus, the mass associated with the large amount of liquid electrolyte which is required significantly decreases the energy stored per unit cell weight that would otherwise be available in lithium oxygen cells.

Operation of Li/O₂ cells depends on the diffusion of oxygen into the air cathode. As such, high oxygen solubility in the electrolyte is desired for the cell to operate under high rate discharge conditions. J. Read (J. Electrochem. Soc., 149(9) A1190-A1195 (2002)), in studying the cathodes of lithium air cells, demonstrated the dependence of cathode capacity on oxygen absorption. Oxygen absorption is a function of electrolyte Bunsen coefficient (a), electrolyte conductivity (σ), and viscosity (η). The trend of decreasing cathode lithium reaction capacity with increasing viscosity and decreasing Bunsen coefficient is apparent in Read's data. It is known that as the solvent's viscosity increases, there are decreases in lithium reaction capacity and Bunsen coefficients. Additionally, the electrolyte has an even more direct effect on overall cell capacity as the ability to dissolve reaction product is crucial. This problem has persisted in one form or another in known batteries.

Indeed, high rates of capacity fade remain a problem for non-aqueous rechargeable lithium air batteries and have represented a significant barrier to their commercialization. The high fade is attributed primarily to parasitic reactions occurring between the electrolyte and the mossy lithium powder and dendrites formed at the anode-electrolyte interface during cell recharge, as well as the passivation reactions between the electrolyte and the LiO₂ radical which occurs as an intermediate step in reducing Li₂O₂ during recharge.

During recharge, lithium ions are conducted across the electrolyte separator with lithium being plated at the anode. The recharge process can be complicated by the formation of low density lithium dendrites and lithium powder as opposed to a dense lithium metal film. In addition to passivation reactions with the electrolyte, the mossy lithium formed during recharge can be oxidized in the presence of oxygen into mossy lithium oxide. A thick layer of lithium oxide and/or electrolyte passivation reaction product on the anode can increase the impedance of the cell and thereby lower performance. Formation of mossy lithium with cycling can also result in large amounts of lithium being disconnected within the cell and thereby being rendered ineffective. Lithium dendrites can penetrate the separator, resulting in internal short circuits within the cell. Repeated cycling causes the electrolyte to break down, in addition to reducing the oxygen passivation material coated on the anode surface. This results in the formation of a layer composed of mossy lithium, lithium-oxide and lithium-electrolyte reaction products at the metal anode's surface which drives up cell impedance and consumes the electrolyte, bringing about cell dry out.

Attempts to use active (non-lithium metal) anodes to eliminate dendritic lithium plating have not been successful because of the similarities in the structure of the anode and cathode. In such lithium air “ion” batteries, both the anode and cathode contain carbon or another electronic conductor as a medium for providing electronic continuity. Carbon black in the cathode provides electronic continuity and reaction sites for lithium oxide formation. To form an active anode, graphitic carbon is included in the anode for intercalation of lithium and carbon black is included for electronic continuity. Unfortunately, the use of graphite and carbon black in the anode can also provide reaction sites for lithium oxide formation. At a reaction potential of approximately 3 volts relative to the low voltage of lithium intercalation into graphite, oxygen reactions would dominate in the anode as well as in the cathode. Applying existing lithium ion battery construction techniques to lithium oxygen cells would allow oxygen to diffuse throughout all elements of the cell structure. With lithium/oxygen reactions occurring in both the anode and cathode, creation of a voltage potential differential between the two is difficult. An equal oxidation reaction potential would exist within the two electrodes, resulting in no voltage.

As a solution to the problem of dendritic lithium plating and uncontrolled oxygen diffusion, known aqueous and non-aqueous lithium air batteries have included a barrier electrolyte separator, typically a ceramic material, to protect the lithium anode and provide a hard surface onto which lithium can be plated during recharge. However, formation of a reliable, cost effective barrier has been difficult. A lithium air cell employing a protective solid state lithium ion conductive barrier as a separator is described in U.S. Pat. No. 7,691,536 of Johnson. Thin film barriers have limited effectiveness in withstanding the mechanical stress associated with stripping and plating lithium at the anode or the swelling and contraction of the cathode during cycling.

Thick lithium ion conductive ceramic plates have also been employed, particularly in lithium water cells. Having thicknesses in the range of 150 um, these plates offer excellent protective barrier properties, however, they are difficult to fabricate and expensive to make. In addition, these ceramic plates add significant mass to the cell, resulting in a reduction in specific energy storage capability. This reduction can be sufficient to negate the otherwise high energy density performance available using lithium-air technology.

As it relates to the cathode, the dramatic decrease in cell capacity as the discharge rate is increased is attributed to the accumulation of reaction product in the cathode. At high discharge rate, oxygen entering the cathode at its surface does not have an opportunity to diffuse or otherwise transition to reaction sites deeper within the cathode. The discharge reactions occur at the cathode surface, resulting in the formation of a reaction product crust that seals the surface of the cathode and prevents additional oxygen from entering. Starved of oxygen, the discharge process cannot be sustained.

Another significant challenge with lithium air cells has been electrolyte stability within the cathode. The high cycle fade of non-aqueous lithium air cells has been attributed to electrolyte reduction reactions that primarily occur during recharge. The primary discharge product in lithium oxygen cells is Li₂O₂. During recharge, the resulting lithium oxygen radical, LiO₂—, an intermediate product which occurs while electrolyzing Li₂O₂, aggressively attacks and decomposes the electrolyte within the cathode, causing it to lose its effectiveness.

High temperature molten salt cells provide a solution to the electrolyte stability problem encountered with organic electrolytes. U.S. Pat. No. 4,803,134 of Sammells describes a high lithium-oxygen secondary cell in which a ceramic oxygen ion conductor is employed. The cell includes a lithium-containing negative electrode in contact with a lithium ion conducting molten salt electrolyte, LiF—LiCl—Li₂O, separated from the positive electrode by the oxygen ion conducting solid electrolyte. The ion conductivity limitations of available solid oxide electrolytes require that such a cell be operated in the 700° C. range or higher in order to have reasonable charge/discharge cycle rates. The geometry of the cell is such that the discharge reaction product accumulates within the molten salt between the anode and the solid oxide electrolyte. The distance between the anode and cathode which is needed to provide space for the reaction product is an additional source of impedance within the cell. Maintaining cells at high temperature consumes energy due to heat loss to the surrounding air from which oxygen is being extracted. The energy consumed in maintaining the desired operating temperature results in less net available electrical power output.

Molten nitrates also offer a viable solution and the physical properties of molten nitrate electrolytes are summarized in Table 1 (taken from Lithium Batteries Using Molten Nitrate Electrolytes by Melvin H. Miles; (1999)).

TABLE 1
Physical properties of Molten Nitrate Electrolytes

| | Mol | Melt Temp | κ (S/cm) | |
|---|---|---|---|---|
| System | % | °C | @570K | at Mol % |
| LiNO₃—KNO₃ | 42-58 | 124 | 0.687 | 50.12 mol % LiNO₃ |
| LiNO₃—RbNO₃ | 30-70 | 148 | 0.539 | 50 mol % RbNO₃ |
| NaNO₃—RbNO₃ | 44-56 | 178 | 0.519 | 50 mol % RbNO₃ |
| LiNO₃—NaNO₃ | 56-44 | 187 | 0.985 | 49.96 mol % NaNO₃ |
| NaNO₃—KNO₃ | 46-54 | 222 | 0.66 | 50.31 mol % NaNO₃ |
| KNO₃—RbNO₃ | 30-70 | 290 | 0.394 | 70 mol % RbNO₃ |

The electrochemical oxidation of the molten LiNO₃ occurs at about 1.1 V vs. Ag+/Ag or 4.5 V vs. Li+/Li. The electrochemical reduction of LiNO₃ occurs at about −0.9V vs. Ag+/Ag, and thus these two reactions define a 2.0V electrochemical stability region for molten LiNO₃ at 300° C. and are defined as follows:

LiNO₃→Li⁺+NO₂+1/2 O₂+e⁻ (Equation 1)

LiNO₃+2e⁻→LiNO₂+O⁻⁻ (Equation 2)

This work with molten nitrates was not performed with lithium air cells in mind; however, the effective operating voltage window for the electrolyte is suitable for such an application. As indicated by the reaction potential line in Scheme 1, applying a recharge voltage of 4.5V referenced to the lithium anode can cause lithium nitrate to decompose to lithium nitrite, releasing oxygen. On the other hand, lithium can reduce LiNO₃ to Li₂O and LiNO₂. This reaction occurs when the LiNO₃ voltage drops below 2.5V relative to lithium. As long as there is dissolved oxygen in the electrolyte, the reaction kinetics will favor the lithium oxygen reactions over LiNO₃ reduction. Oxide ions are readily converted to peroxide (O₂²⁻) and aggressive superoxide (O₂⁻) ions in NaNO₃ and KNO₃ melts (M. H. Miles et al., J. Electrochem. Soc., 127,1761 (1980)). These cells also have the limitation of needing to consume energy in maintaining operating temperature.

In 2015, Vincent Giordani of Liox Power, Inc. reported high temperature molten salt system using nitrates. Nitrate and halide salts have the stability needed for the lithium oxygen environments, high ion conductivity and the ability to dissolve lithium oxygen and lithium carbonate reaction products. The challenge faced with these systems is primarily associated with disposition of reaction products. Similar to the non-aqueous, organic electrolyte cells, accumulation of discharge reaction product within the cell tends to interfere with migration of reactants to reaction sites and thereby limit cell performance.

A lithium air battery which exhibits a high rate of cell charge/discharge with limited capacity fade, high energy density, high power density and the ability to operate on oxygen from ambient air is described in U.S. Patent Application Publication No. 2020/0321662 of Johnson. This prior art battery removes significant barriers that have prevented the commercialization of lithium air cells. For example, the mossy lithium powder and dendrites at the anode-electrolyte interface formed during cell recharge are eliminated by using molten lithium supplied as a flow reactant to the anode side of a stable solid state ceramic electrolyte. A flow system for removing reaction product from the cathode is also described.

Attempts have been made to minimize heat loss to the ambient air by including recuperative heat exchangers for air flowing into and out of the battery. However, such attempts have not be very successful to date, such that heat loss to the surrounding air remains a problem of lithium air batteries.

A need remains for a lithium air cell which overcomes problems associated with those of the prior art.

### BRIEF SUMMARY OF THE INVENTION

Embodiment 1: In one aspect, the present invention is directed to a lithium air battery system comprising a thermally insulating housing, the thermally insulating housing having at least one wall including at least one heat reflective layer and at least one vacuum layer; at least one lithium air cell positioned inside the thermally insulating housing; a supply of air; a recuperative heat exchanger; and a first conduit and a second conduit, the first and second conduits coupling the heat exchanger with the thermally insulating housing. During operation, the first conduit conducts air flow in a first direction through the recuperative heat exchanger and into the thermally insulating housing and the second conduit conducts air flow out of the thermally insulating housing and through the recuperative heat exchanger in a second direction which is opposite to the first direction, the recuperative heat exchanger being configured to transfer heat from the air flowing out of the thermally insulating housing to the air flowing into the thermally insulating housing.

Embodiment 2: In one aspect, the present invention is directed to the lithium air battery system according to Embodiment 1, wherein the thermally insulating housing comprises a plurality of walls, each wall including the at least one heat reflective layer and the at least one vacuum layer.

Embodiment 3: In one aspect, the present invention is directed to the lithium air battery system according to any of the preceding embodiments, wherein the at least one wall includes a plurality of spaced-apart heat reflective layers and a plurality of vacuum layers arranged in an alternating manner.

Embodiment 4: In one aspect, the present invention is directed to the lithium air battery system according to any of the preceding embodiments, wherein the thermally insulating housing comprises a base and a cover configured to be selectively secured to each other, each of the base and the cover comprising the at least one wall including the at least one heat reflective layer and the at least one vacuum layer.

Embodiment 5: In one aspect, the present invention is directed to the lithium air battery system according to the preceding embodiment, wherein the at least one wall of each of the base and cover includes a plurality of spaced-apart heat reflective layers and a plurality of vacuum layers arranged in an alternating manner.

Embodiment 6: In one aspect, the present invention is directed to the lithium air battery system according to any of the preceding embodiments, wherein at least a portion of an interior surface of the at least one heat reflective layer comprises a heat reflective coating.

Embodiment 7: In one aspect, the present invention is directed to the lithium air battery system according to any of the preceding embodiments, further comprising a first valve configured to control air flow into the thermally insulating housing and a second valve configured to control air flow out of the thermally insulating housing, wherein when the first and second valves are in a closed position, air circulation through the system is shut down.

Embodiment 8: In one aspect, the present invention is directed to the lithium air battery system according to any of the preceding embodiments, further comprising a heater which maintains a temperature inside the thermally insulating housing at an operating temperature of the at least one lithium air cell.

Embodiment 9: In one aspect, the present invention is directed to the lithium air battery system according to any of the preceding embodiments, wherein the at least one heat reflective layer prevents or minimizes radiative heat loss.

Embodiment 10: In one aspect, the present invention is directed to the lithium air battery system according to any of the preceding embodiments, wherein the at least one vacuum layer prevents or minimizes conductive and/or convective heat loss.

Embodiment 11, in an aspect, the present invention is directed to a lithium air battery system comprising at least one lithium air cell; a thermally insulating housing configured to house the at least one lithium air cell, the thermally insulating housing having at least one wall including at least one thermally insulating layer and at least one vacuum layer, the at least one thermally insulating layer having an interior surface configured to reflect heat radiated by the at least one lithium air cell, the at least one vacuum layer being configured to insulate the at least one lithium air cell from conductive and/or convective heat transfer to an external surface of the thermally insulating housing; a supply of air; a recuperative heat exchanger; and a first conduit and a second conduit, the first and second conduits coupling the heat exchanger with the thermally insulating housing. During operation, the first conduit conducts air flow in a first direction through the recuperative heat exchanger and into the thermally insulating housing and the second conduit conducts air flow out of the thermally insulating housing and through the recuperative heat exchanger in a second direction which is opposite to the first direction, the recuperative heat exchanger being configured to transfer heat from the air flowing out of the thermally insulating housing to the air flowing into the thermally insulating housing.

Embodiment 12: In one aspect, the present invention is directed to the lithium air battery system according to the preceding embodiment, wherein the thermally insulating housing comprises a plurality of walls, each wall including the at least one thermally insulating layer and the at least one vacuum layer.

Embodiment 13: In one aspect, the present invention is directed to the lithium air battery system according to either Embodiment 11 or 12, wherein the at least one wall includes a plurality of spaced-apart thermally insulating layers and a plurality of vacuum layers arranged in an alternating manner.

Embodiment 14: In one aspect, the present invention is directed to the lithium air battery system according to any of Embodiments 11-13, wherein the thermally insulating housing comprises a base and a cover configured to be selectively secured to each other, each of the base and the cover comprising the at least one wall including the at least one thermally insulating layer and the at least one vacuum layer.

Embodiment 15: In one aspect, the present invention is directed to the lithium air battery system according to the preceding embodiment, wherein the at least one wall of each of the base and cover includes a plurality of spaced-apart thermally insulating layers and a plurality of vacuum layers arranged in an alternating manner.

Embodiment 16: In one aspect, the present invention is directed to the lithium air battery system according to any of Embodiments 11-15, wherein at least a portion of the interior surface of the at least one thermally insulating layer comprises a thermal reflective coating.

Embodiment 17: In one aspect, the present invention is directed to the lithium air battery system according to any of Embodiments 11-16, further comprising a first valve configured to control air flow into the thermally insulating housing and a second valve configured to control air flow out of the thermally insulating housing, wherein when the first and second valves are in a closed position, air circulation through the system is shut down.

Embodiment 18: In one aspect, the present invention is directed to the lithium air battery system according to any of Embodiments 11-17, further comprising a heater which maintains a temperature inside the thermally insulating housing at an operating temperature of the at least one lithium air cell.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of a lithium air battery system, according to one embodiment of the present invention, with the battery housing in an open configuration in which the cover is not assembled with the base;

FIG. 2 is a schematic of a lithium air battery system, according to one embodiment of the present invention, in an operational state with the battery housing in a closed configuration in which the cover is sealed against the base; and

FIG. 3 is a schematic of a lithium air battery system, according to one embodiment of the present invention, in a non-operational state with the battery housing in the closed configuration.

### DETAILED DESCRIPTION OF THE INVENTION

This disclosure generally relates to energy storage, and more particularly to a lithium air battery system. For the purposes of this disclosure, the terms lithium air cell, lithium air battery, lithium air electrochemical engine, rechargeable lithium air battery, and lithium oxygen battery are used interchangeably.

Certain terminology is used in the following description for convenience only and is not limiting. The words “proximal,” “distal,” “upward,” “downward,” “bottom” and “top” designate directions in the drawings to which reference is made. The words “inwardly” and “outwardly” refer to directions toward and away from, respectively, a geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

It will also be understood that terms such as “first,” “second,” and the like are provided only for purposes of clarity. The elements or components identified by these terms, and the operations thereof, may easily be switched.

Aspects of the disclosure relate to a lithium air battery system comprising at least one lithium air cell, and more preferably a plurality of lithium air cells, which operate at an elevated temperature, preferably above 100° C. More preferably, the lithium air cells operated in the range of 100° C. to 700° C., and most preferably 500° C. to 700° C. Preferably, the lithium air cells operate in the range of about 250° C. to 650° C., more preferably about 250° to 400° C. or about 400° C. to 650° C., depending on the specific electrolyte contained in the battery. The present invention minimizes wasteful loss of the electrochemical power output potential of the cells by minimizing heat loss and thereby the amount of energy that otherwise would be consumed in maintaining the cells at their required operating temperatures.

Specifically, the lower operating temperature range is preferred when the molten electrolyte contains siloxanes and the higher operating temperature range is preferred when the electrolyte contains only inorganic molten salts. Operation at elevated temperature enables faster kinetics for higher power density, thus eliminating a major problem associated with lithium air technology. Further, operation at elevated temperature also allows the use of high temperature organic electrolytes and inorganic, molten salt electrolyte solutions that have high electrochemical stability, thus avoiding another of the major problems that has plagued the conventional approach to lithium air cells. Selected inorganic molten salts have good solubility of lithium/oxygen reaction products, thus allowing better control of cell kinetics.

Aspects of the present disclosure also relate to a thermally insulating enclosure system for optimizing operating efficiency of the lithium air cells. The thermally insulating enclosure system includes a thermal insulation containment device, a recuperative heat exchanger and an air flow actuator configured to provide ambient air to the high temperature lithium air cells by minimizing energy loss to ambient air as the cells operate. Aspects of the present disclosure also relate to integration of one or more lithium air cells into an overall lithium air battery system in a manner which results in high energy density and high specific energy storage.

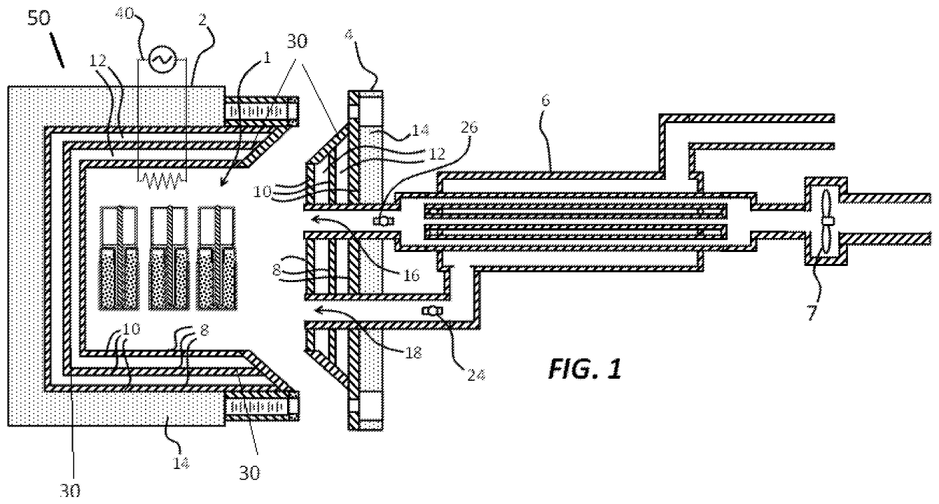

Referring to FIG. 1, the rechargeable lithium air battery system according to aspects of the disclosure contains one or more lithium air cells 1, a thermally insulating enclosure system comprised of a battery housing 50, and an air flow actuator 7. In one embodiment, the system further includes an inlet air flow control valve 26 and an outlet air flow control valve 24. In one embodiment, the system further includes a recuperative heat exchanger 6. In one embodiment, a heater 40, and more preferably an electric heater 40, is provided to maintain the temperature inside the battery housing 50 at the operating temperature of the lithium air cells 1.

The lithium air cells 1 may have any configuration which is known in the art, such as the cell configurations disclosed in U.S. Pat. No. 10,218,044 of Johnson or U.S. Patent Application Publication No. 2020/0321662 of Johnson, the disclosures of which are incorporated herein by reference thereto, or a configuration which is yet to be developed. The design of the thermally insulating enclosure system is not fundamentally dependent on the configuration of the cells.

Generally, in one embodiment, each lithium air cell 1 comprises a lithium-based anode comprising a lithium ion conductive ceramic electrolyte forming a first chamber that encloses molten lithium metal, an oxygen electrode which functions as the positive electrode of the cell, a solid oxygen ion conductive electrolyte forming a second chamber, and a molten salt electrolyte contained in the second chamber and coupled between the oxygen ion conductive electrolyte and the lithium ion conductive electrolyte, such that lithium reaction product accumulates within the second chamber and the molten electrolyte has no contact with air.

With high temperature air flow through the system, each cell 1 extracts oxygen from the air flow during discharge and releases oxygen into the air flow during recharge. For example, with the cells 1 configured as disclosed in U.S. Patent Application Publication No. 2020/0321662 of Johnson, during discharge, lithium is oxidized into lithium ions and electrons at the solid electrolyte interface. The electrons are conducted through an external load to the cathode electrode terminal. The lithium ions are conducted through the solid lithium ion conductive ceramic electrolyte into the molten salt electrolyte. Simultaneously, oxygen is oxidized at the cathode interface with the solid oxygen ion conductive electrolyte. The electrons are conducted through the external load to the anode electrode terminal, while the resulting oxygen ions are conducted through the solid oxygen ion conductive electrolyte and into the molten salt electrolyte, thereby completing the reaction with lithium entering through solid lithium ion conductive ceramic electrolyte to form lithium oxide. Lithium reaction product accumulates within second chamber. The opposite occurs during charge, with lithium ions being conducted from the molten salt electrolyte through the solid lithium ion conductive ceramic electrolyte and reduced to lithium metal as electrons are coupled to the cathode electrode terminal, and oxygen ions are conducted from the molten salt electrolyte through the solid oxygen ion conductive electrolyte to reaction sites in the cathode where they are reduced to oxygen and released to external air.

The rechargeable lithium air battery system according to an embodiment of the present invention is shown with the battery housing 50 in an open state. The battery housing 50 comprises a housing base 2 and a housing cover 4 configured to enclose one or more battery cells 1. The base 2 and cover 4 are selectively attachable to and detachable from each other, as described hereinafter in greater detail. In the open state, as shown in FIG. 1, the base 2 and cover 4 are not assembled together with each other.

The base 2 preferably comprises one or more walls 30 which define an interior space configured to accommodate the one or more battery cells 1. As shown in FIG. 1, the cover 4 may be removed from or assembled to one side or end of the base 2. Thus, the battery housing 50 may be opened by removing the cover 4 from the base 2 so as to provide access to the interior of the base 2 and the battery cells 1 positioned therein. The cover 4 preferably also comprises at least one wall 30. Collectively, the walls 30 of the base 2 and cover 4 are hereinafter referred to as walls 30 of the battery housing 50.

Each wall 30 of the battery housing 50 comprises at least one layer 10, and more preferably a plurality of spaced-apart layers 10. In one embodiment, each layer 10 comprises a heat reflective material. In one embodiment, a heat reflective coating or layer is provided on at least a portion or the entirety of an interior surface 8 of each layer 10. The interior surface 8 of each layer 10 is the surface facing the interior of the battery housing 50. The heat reflective material is preferably capable of preventing or reducing radiated heat transfer; e.g., a radiant barrier. Preferably, the interior surface 8 of each layer 10 is an infrared (heat) reflective mirror-like surface capable of preventing or reducing radiated heat transfer. As such, each layer 10 is a heat reflective layer, also referred to as a thermally insulating layer.

In one embodiment, each layer 10 is formed of a thermally insulating material with the interior surface 8 partially or entirely being formed of a heat reflective material. In another embodiment, the entire body of each layer 10 is formed of a heat reflective material. In another embodiment, the entire body of each layer 10 is formed of a thermally insulating material.

Preferably, the layers 10 are configured to prevent or reduce heat dissipation from the battery cells 1 to the outside of the battery housing 50, and more particularly the heat insulating layers 10 prevent or reduce (minimize) radiative heat loss from the battery cells 1 to the outside of the battery housing 50. As such, the battery housing 50 is a thermally insulating housing.

In one embodiment, each layer 10 comprises a reflective material such as, but not limited to, mirrored glass, polished stainless steel, polished aluminum or other suitable material having a prepared reflective surface. Preferably, the material of each layer 10 is polished aluminum to minimize the overall weight of the battery housing 50. Each layer 10 of each wall 30 of the battery housing 50 may be formed of the same material or combination of materials, or of a different material or combination of materials. Each layer 10 of each wall 30 of the battery housing 50 preferably has a thickness of approximately 0.016 inch to approximately 0.5 inch, more preferably approximately 0.0625 inch. The layers 10 of each wall 30 may have the same or different thicknesses.

The walls 30 of the battery housing 50 preferably further include at least one vacuum layer 12. More particularly, the layers 10 of each wall 30 are spaced apart with the regions in between the layers 10 evacuated to minimize or eliminate any mechanism for conductive heat transfer. More particularly, the regions between the plurality of layers 10 of the walls 30 of the battery housing 50 are preferably vacuum gaps or layers 12 which prevent or minimize heat loss, and more particularly conductive and/or convective heat loss to an external surface of the battery housing 50. Each vacuum gap 12 preferably has a thickness of approximately 0.016 inch to approximately 0.5 inch, preferably approximately 0.125 inch.

It will be understood by those skilled in the art that the thicknesses of the heat reflective layers 10 and/or the vacuum layers 12 may be increased or decreased depending on manufacturing constraints.

In one embodiment, at least a portion of the exterior of the base 2 and cover 4 of the battery housing 50 are provided with a further layer 14 comprising a thermally insulating material. The additional thermally insulating layer 14 provides added protection against heat loss from the cells 1 to the outside environment. Examples of the thermally insulating material that may be used to form either layer 14 or layers 10 include and conventional insulation material, such as, but not limited to, fiber glass felt, polymer foam or similar material.

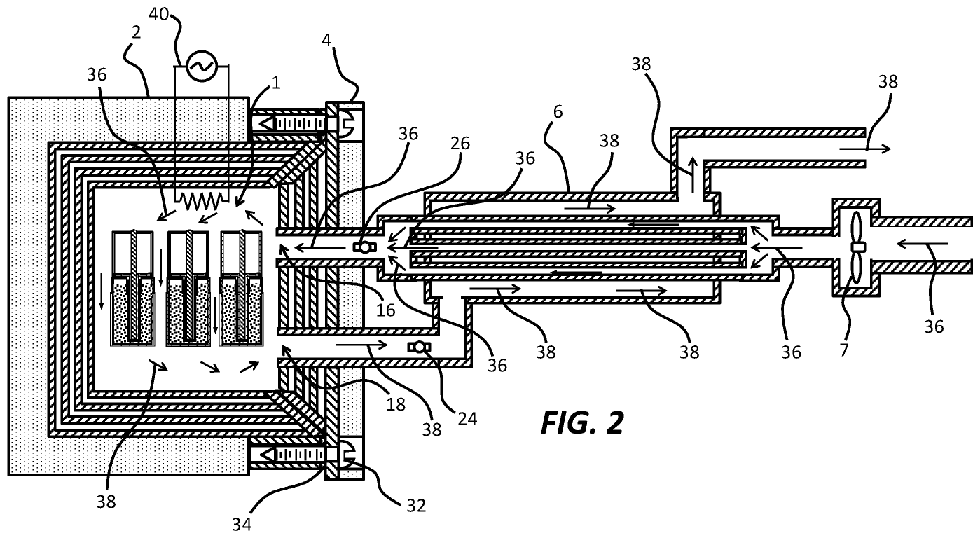

During operation, the battery housing 50 is placed in its closed state, as shown in FIG. 2. In the closed state, the cover 4 is assembled with the base 2. More particularly, the cover 4 is positioned over and secured to the open end of the base 2. Referring to FIG. 2, in one embodiment, a seal 34 is provided between the cover 4 and base 2, to prevent air ingress or egress at the interface of the base 2 and cover 4. In one embodiment, one or more fasteners 32 are used to hold the cover 4 against the seal 34 and base 2, such that the cells 1 are completely enclosed within the battery housing 50.

In the closed state, the interior of the battery housing 50 in which the cells 1 are housed may be maintained at the desired nominal temperature, or in other words within the desired high temperature operational range of the cells 1, due to the thermally insulating structures of the base 2 and cover 4. It will be understood by those skilled in the art that the effectiveness of the battery housing 50 and control of the temperature in the interior of the battery housing 50 may be adjusted as desired by adjusting factors such as the number of layers 10, the quality of the interior reflective surfaces 8 of the layers 10, the materials of the layers 10, the quality of the vacuum layers 12, and the like.

The recuperative heat exchanger 6 is preferably a tube and shell counter flow recuperative heat exchanger. A first conduit 16 and a second conduit 18 are provided to couple the recuperative heat exchanger 6 to the battery housing 50. One end of each conduit 16, 18 is in direct communication with the heat exchanger 6, while the other end of each conduit 16, 18 is in direct communication with the interior of the closed battery housing 50. As such, the heat exchanger 6 is in flow communication with the interior of the battery housing 50. In one embodiment, as shown in FIG. 1, the first and second conduits 16, 18 are received or integrally formed within openings formed in the cover 4. Thus, the first and second conduits 16, 18 may be removeable from the cover 4 or may be integrally formed with the cover 4.

The first conduit 16 conducts air flow 36 into the battery housing 50 and the second conduit 18 conducts air flow 38 out of the battery housing 50. The first conduit 16, also referred to herein as the air inlet conduit, is equipped with the inlet air flow control valve 26, while the second conduit 18, also referred to herein at the air outlet conduit, is equipped with the outlet air flow control valve 24.

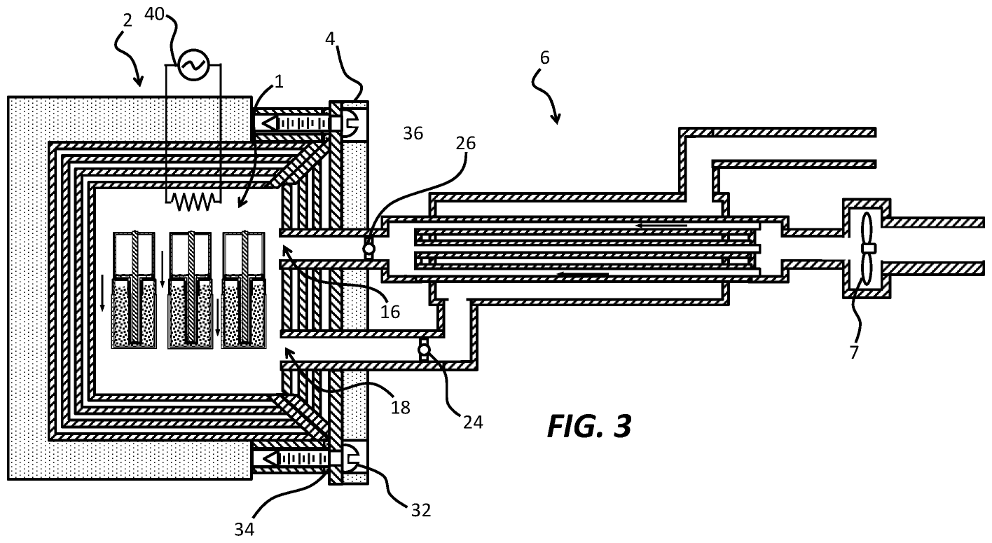

FIG. 3 depicts the battery housing 50 in its closed state, but with the inlet and outlet air flow control valves 26, 24 in the closed position, such that the battery system is not operational. The air flow control valves 24, 26 provide the ability to monitor the performance of the battery system. In the closed position, in particular, the air flow control valves 24, 26 enable cutting off the air flow from reaching the cells 1 in the event of system downtime (e.g., for maintenance) and/or undesired operating conditions, such as a cell breach, fire or other hazardous condition.

FIG. 2 shows the battery housing 50 in its closed state with the inlet and outlet air flow control valves 26, 24 in the open position, such that the battery system is operational. During operation, the air flow actuator 7, which is positioned upstream of the heat exchanger 6 and cells 1, forces air flow through the heat exchanger 6 and the battery housing 50. The incoming air is utilized by the cells 1 to generate electricity, as discussed above.

More particularly, the air flow actuator 7 forces air flow through the inner tube(s) of the heat exchanger 6, then through the air inlet conduit 16 (the incoming air flow being indicated by arrows 36 in FIG. 2), and finally into the battery housing 50. In the battery housing 50, the air flows among the cells 1, and more particularly around each cell 1 to sustain operation of the cells 1. The air flow exits the battery housing 50 via the air outlet conduit 18 (the outgoing air flow being indicated by arrows 38 in FIG. 2) and flows over the outside of the tube(s) of the heat exchanger 6. The incoming air 36 is therefore heated inside the heat exchanger 6 by the air 38 exiting the high temperature battery housing 50 and flowing in the opposite direction as the incoming air 36 through the heat exchanger 6. Recovering or recuperating heat from the exiting air 38 to heat the incoming air 36 minimizes the amount of power consumed and needed by the electric heater 40 to maintain the cells 1 at the desired nominal operating temperatures.

It will also be understood by those skilled in the art that a certain amount of heating will occur during operation of the battery cells 1 due to internal resistance of the cells 1.

It will also be understood by those skilled in the art that while the disclosure provided herein refers primarily to lithium air cells, the thermally insulating housing could be utilized with other types of high-temperature metal air cells, such as sodium-air batteries, potassium-air batters, zin-air batteries, magnesium-air batteries, calcium-air batteries, aluminum-air batteries and iron-air batteries.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A lithium air battery system comprising:
a thermally insulating housing, the thermally insulating housing having at least one wall including at least one heat reflective layer and at least one vacuum layer;
at least one lithium air cell positioned inside the thermally insulating housing;
a supply of air;
a recuperative heat exchanger; and
a first conduit and a second conduit, the first and second conduits coupling the heat exchanger with the thermally insulating housing,
wherein, during operation, the first conduit conducts air flow in a first direction through the recuperative heat exchanger and into the thermally insulating housing and the second conduit conducts air flow out of the thermally insulating housing and through the recuperative heat exchanger in a second direction which is opposite to the first direction, the recuperative heat exchanger being configured to transfer heat from the air flowing out of the thermally insulating housing to the air flowing into the thermally insulating housing.

2. The lithium air battery system according to claim 1, wherein the thermally insulating housing comprises a plurality of walls, each wall including the at least one heat reflective layer and the at least one vacuum layer.

3. The lithium air battery system according to claim 1, wherein the at least one wall includes a plurality of spaced-apart heat reflective layers and a plurality of vacuum layers arranged in an alternating manner.

4. The lithium air battery system according to claim 1, wherein the thermally insulating housing comprises a base and a cover configured to be selectively secured to each other, each of the base and the cover comprising the at least one wall including the at least one heat reflective layer and the at least one vacuum layer.

5. The lithium air battery system according to claim 4, wherein the at least one wall of each of the base and cover includes a plurality of spaced-apart heat reflective layers and a plurality of vacuum layers arranged in an alternating manner.

6. The lithium air battery system according to claim 1, wherein at least a portion of an interior surface of the at least one heat reflective layer comprises a heat reflective coating.

7. The lithium air battery system according to claim 1, further comprising a first valve configured to control air flow into the thermally insulating housing and a second valve configured to control air flow out of the thermally insulating housing, wherein when the first and second valves are in a closed position, air circulation through the system is shut down.

8. The lithium air battery system according to claim 1, further comprising a heater which maintains a temperature inside the thermally insulating housing at an operating temperature of the at least one lithium air cell.

9. The lithium air battery system according to claim 1, wherein the at least one heat reflective layer prevents or minimizes radiative heat loss.

10. The lithium air battery system according to claim 1, wherein the at least one vacuum layer prevents or minimizes conductive and/or convective heat loss.

11. A lithium air battery system comprising:
at least one lithium air cell;
a thermally insulating housing configured to house the at least one lithium air cell, the thermally insulating housing having at least one wall including at least one thermally insulating layer and at least one vacuum layer, the at least one thermally insulating layer having an interior surface configured to reflect heat radiated by the at least one lithium air cell, the at least one vacuum layer being configured to insulate the at least one lithium air cell from conductive and/or convective heat transfer to an external surface of the thermally insulating housing;
a supply of air;
a recuperative heat exchanger; and
a first conduit and a second conduit, the first and second conduits coupling the heat exchanger with the thermally insulating housing,
wherein, during operation, the first conduit conducts air flow in a first direction through the recuperative heat exchanger and into the thermally insulating housing and the second conduit conducts air flow out of the thermally insulating housing and through the recuperative heat exchanger in a second direction which is opposite to the first direction, the recuperative heat exchanger being configured to transfer heat from the air flowing out of the thermally insulating housing to the air flowing into the thermally insulating housing.

12. The lithium air battery system according to claim 11, wherein the thermally insulating housing comprises a plurality of walls, each wall including the at least one thermally insulating layer and the at least one vacuum layer.

13. The lithium air battery system according to claim 11, wherein the at least one wall includes a plurality of spaced-apart thermally insulating layers and a plurality of vacuum layers arranged in an alternating manner.

14. The lithium air battery system according to claim 11, wherein the thermally insulating housing comprises a base and a cover configured to be selectively secured to each other, each of the base and the cover comprising the at least one wall including the at least one thermally insulating layer and the at least one vacuum layer.

15. The lithium air battery system according to claim 14, wherein the at least one wall of each of the base and cover includes a plurality of spaced-apart thermally insulating layers and a plurality of vacuum layers arranged in an alternating manner.

16. The lithium air battery system according to claim 11, wherein at least a portion of the interior surface of the at least one thermally insulating layer comprises a thermal reflective coating.

17. The lithium air battery system according to claim 11, further comprising a first valve configured to control air flow into the thermally insulating housing and a second valve configured to control air flow out of the thermally insulating housing, wherein when the first and second valves are in a closed position, air circulation through the system is shut down.

18. The lithium air battery system according to claim 11, further comprising a heater which maintains a temperature inside the thermally insulating housing at an operating temperature of the at least one lithium air cell.
